(19) United States
(12) Patent Application Publication
(10) Pub. No.: US 2017/0267457 A1
(43) Pub. Date: Sep. 21, 2017

(54) WEAR-RESISTANT CERAMIC LINER WITH SNAP-LOCK FIXING ARRANGEMENT

(71) Applicant: TEGA INDUSTRIES LIMITED, Kolkata (IN)

(72) Inventors: Shanti Bhushan SINGH, Kolkata (IN); Goutam GHOSH, Kolkata (IN)

(73) Assignee: TEGA INDUSTRIES LIMITED, Kolkata (IN)

(21) Appl. No.: 15/529,353

(22) PCT Filed: Jan. 13, 2015
(86) PCT No.: PCT/IN2015/000016

§ 371 Date: May 24, 2017

(30) Foreign Application Priority Data
Nov. 27, 2014 (IN) 1253/KOL/2014

(51) Int. Cl. B65G 21/20; B65G 11/16

(52) U.S. Cl. CPC B65G 21/2081; B65G 11/166

(57) ABSTRACT

A wear-resistant ceramic liner (7) with snap-lock fixing arrangement (1) comprises of a plurality of male parts (2) positioned on mother plate (3) and a plurality of corresponding female parts (5) formed on liner (7). The external contours of the male parts (2) match exactly the Internal contours of their corresponding female parts (5). There is a snap fit between these two parts when the male part is inserted into the corresponding female part to form the snap-lock fixing arrangement. The male part (2) is either integral to said mother plate (3) or welded to it. The ceramic liner is either a square ceramic tiles arrangement or an interlocked type arrangement of ceramic tiles.

### FIELD OF THE INVENTION

The present invention in general relates to fixing of wear-resistant liner with the mother plate to prevent spillage of bulk material from conveyor belt systems in mining and quarrying industries and to prevent the bulk material from abrading the inner side of the mother plate. More particularly, the present invention relates to a wear-resistant liner with snap-lock fixing arrangement, wherein the liner is mounted on the inner side of the mother plate by a snap-fit type fixing arrangement.

### BACKGROUND OF THE INVENTION

A belt conveyer system comprises a belt that extends in a continuous loop around rollers where the upper portion of the continuous loop, known as a transfer run, and the lower portion of the continuous loop, known as a return run. Bulk material is loaded onto the belt at one or more loading zones along the transfer run. When the material is dropped on the conveyor from the chute some material bounces off the conveyor due to elastic collision between the material and the belt.

This is known as spillage or loss of material. To prevent such spillage, most chutes comprise rigid skirts that extend downwards toward the belt for purposes of redirecting stray bulk material and restricting such material on the belt. The skirts often continue for some distance downstream of the chute to provide time for the bulk material to come to rest relative to the belt. With the increase in tonnage it has been observed that the mother plate wears out very fast, because several types of bulk materials are abrasive. It is also a common practice to attach wear liners to the skirts, which prevent the skirts from direct contact with the bulk material. The wear liners therefore wear from direct contact with the moving bulk material and must be periodically replaced. However, such wear is expected. There is a huge problem to fix sealing block and liner at both sides of skirt plate as the sealing block is to be fixed outside the skirt and the liner is to be fixed inside the skirt. In such cases, the liner cannot be fixed by means of bolts because the tail ends of bolts would then project outside the skirt, and thus cannot allow fixing the sealing block. In any case, if the liner is to be fixed by studs, flow of materials would be obstructed either by projected studs or by the counter holes at fixing positions of liners and would result in faster wearing out of studs.

U.S. Pat. No. 7,980,377 B2 discloses a protective and containment component suitable for use as a liner or skirt in a conveyer system e.g. at a chute or belt, and more particularly, is concerned with an arrangement for mounting of a protective component.

There are various costs, linked to the wear related problems which directly and indirectly affect productivity, such as cleanup cost, high maintenance cost, increased power cost per ton of material handled and the loss of material cost that cannot be salvaged. Simultaneously, the life of the equipment goes down. There is significant production loss and the medical expenses due to injury to workmen arising out of unsafe working condition. Moreover the interest cost on the working capital also increases.

Such maintenance operations also cause hindrance to the screening operation. This sort of maintenance operations led to loss of the machine's production capacity. Such losses need to be kept at a minimum.

There has thus been a persistent need to design a suitable fixing arrangement or fastener system that can be used in conjunction with suitable skirt block for its application in mining and quarrying industries so that the replacement process is simple, require less human intervention and also less time consuming, hence reducing the downtime of the plant.

The present invention meets the aforesaid long felt need.

### OBJECTS OF THE INVENTION

How the foregoing objects are achieved will be clear from the following description. In this context it is clarified that the description provided is non-limiting and is only by way of explanation.

The principal object of the present invention is to provide a fixing arrangement for a wear-resistant liner which has a very simple construction and mode of operation, so that removal and replacement operations of the liner can be undertaken in a simple and less time consuming manner.

Another object of the present invention is to provide a fixing arrangement for a wear-resistant liner which is reliable and economic.

A further object of the present invention is to provide a fixing means which can be precision made and can be easily maintained, thereby improving the quality and productivity of conveyer system.

Yet another object of the present invention is to provide a fixing arrangement for a wear-resistant liner on the inner side of the mother plate, so that the skirt board can be easily fixed at the outer surface of the mother plate.

It is a further object of the present invention to provide a wear-resistant liner of reduced weight which can be used from both ends, whereby when one half is eroded, the skirt is flipped to the next half.

How the foregoing objects are achieved and the other aspects of the present invention will be clear from the following description which is purely exemplary and does not impose any limitation on the scope of the invention.

### SUMMARY OF THE INVENTION

A wear-resistant ceramic liner is provided with snap-lock fixing arrangement for easy fixing and detachment.

The snap-lock fixing arrangement comprises of a plurality of male parts positioned on a mother plate and a plurality of corresponding female parts formed on the liner. The external contour of the male parts match exactly the internal contour of the corresponding female parts in such a way that there is a snap fit between these two parts when the male part is inserted into the corresponding female part to form the snap-lock fixing arrangement.

The male part of the wear-resistant ceramic liner is either integral to the mother plate or is welded to the mother plate.

The ceramic liner is either a square ceramic tiles arrangement or an interlocked type arrangement of ceramic tiles. The ceramic tiles are embedded on a rubber or PU matrix for providing padding effect against the impact load.

A steel angel with miter cut present all side to make the liner intact with respect to the shape and size.

The ceramic liner can be used from both ends, whereby when one half is eroded, the skirt is flipped to the next half.

The snap-lock fixing arrangement has no backing plate in order to reduce the overall weight.

### BRIEF DESCRIPTION OF THE ACCOMPANYING DRAWINGS

The nature and scope of the present invention will be better understood from the accompanying drawings, which are by way of illustration of a preferred embodiment which is exemplary and does not impose any limitation on the scope of the invention. In the accompanying drawings,

FIG. 1a is a cross sectional view of conveyor with side skirt sealing and snap-lock fixing arrangement in accordance with a preferred embodiment of the present invention.

FIG. 1b is a side view along line X-X of FIG. 1a.

FIG. 2 is the enlarged view of the snap-lock fixing arrangement shown in ‘A’ of FIG. 1.

FIG. 3a is a further enlarged view showing details of the male part of FIG. 2.

FIG. 3b is a further enlarged view showing details of the female part of FIG. 2.

FIG. 4 is an enlarged view of the male part (enlarged view of ‘B’ of FIG. 3a) and that of the female part (enlarged view of ‘C’ of FIG. 3b) showing their contour details according to the present invention.

FIG. 5 is an enlarged view of ‘D’ of FIG. 1b and view Y-Y of FIG. 2 showing a wear-resistant liner with square blocks.

FIG. 6 is an enlarged view of a wear-resistant liner with interlocking ceramic tiles which can be provided with the snap-lock fixing arrangement of this invention.

### DETAILED DESCRIPTION OF THE INVENTION

Having described the main features of the invention above, a more detailed and non-limiting description of a preferred embodiment will be given in the following paragraphs with reference to the accompanying drawings.

In all the figures, like reference numerals represent like features. Further, the shape, size and number of the devices shown are by way of example only and it is within the scope of the present invention to change their shape, size and number without departing from the basic principle of the invention.

Further, when in the following it is referred to “top”, “bottom”, “upward”, “downward”, “above” or “below”, “right hand side”, “left hand side” and similar terms, this is strictly referring to an orientation with reference to the apparatus, where the base of the apparatus is horizontal and is at the bottom portion of the figures. The number of components shown is exemplary and not restrictive and it is within the scope of the invention to vary the shape and size of the apparatus as well as the number of its components, without departing from the principle of the present invention.

All through the specification including the claims, the technical terms and abbreviations are to be interpreted in the broadest sense of the respective terms, and include all similar items in the field known by other terms, as may be clear to persons skilled in art. Restriction or limitation if any referred to in the specification, is solely by way of example and understanding the present invention.

The present invention provides for sealing the gap between skirt and conveyor to reduce spillage the materials. This new generation advanced innovative new composite liner has a highly wear resistant surface of alumina ceramic tiles (mechanically interlocked ceramic/hexagonal/square ceramic) which are embedded on a Rubber or Polyurethane matrix for providing padding effect along with steel angle with miter cut all side to make the liner rigid with respect to shape and size. The liner is provided with an innovative snap-lock fixing arrangement of liner assembly with the skirt plate which does not allow the liner to move in any direction, hence it eliminates the chances of falling as well as loosening the fixing arrangement completely.

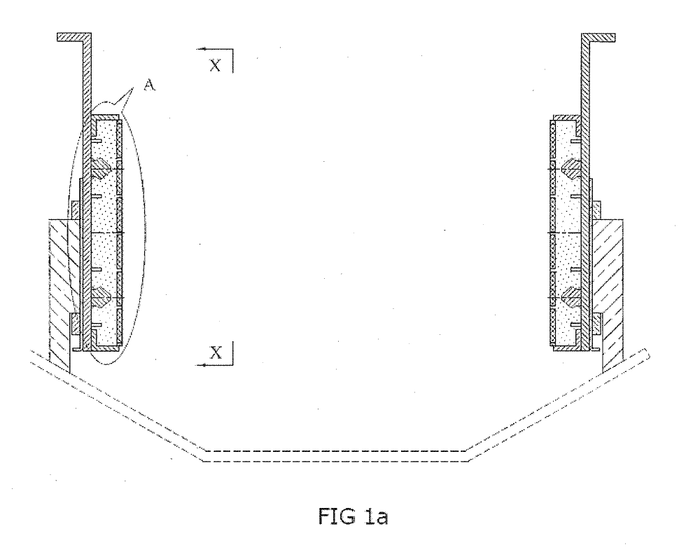

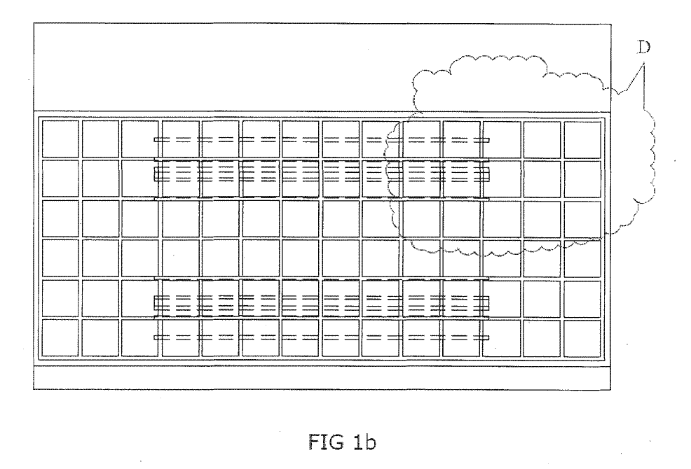

FIG. 1a shows a cross sectional view of a conveyor with side skirt sealing and fixing arrangement in accordance with a preferred embodiment of the present invention, while FIG. 1b is the view along line X-X of FIG. 1a. Together, these two figures give a general idea as to how the snap-lock fixing arrangement is deployed in actual use.

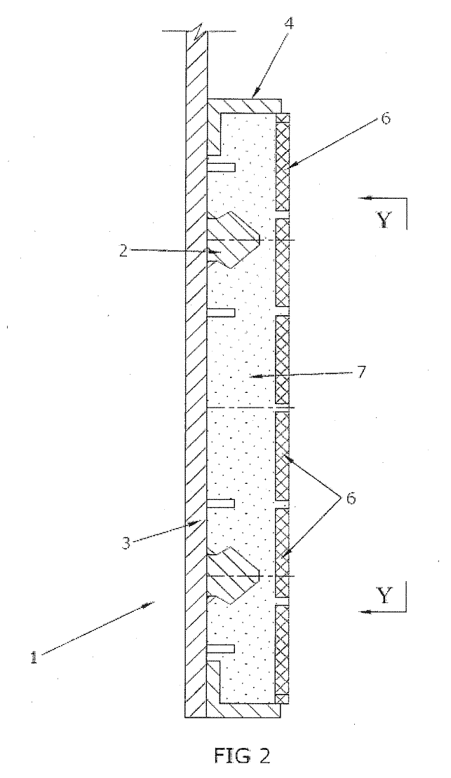

FIG. 2 shows an enlarged view of the portion marked ‘A’ in FIG. 1a. This is the portion which shows the snap-lock fixing arrangement (1) according to the present invention. This innovative snap-lock fixing arrangement has been designed for severe duty applications. The snap-lock arrangement (1) is provided over approximately ½ to ⅓ of the skirt length. Maintenance can be carried out without hampering production. The deign innovation makes it possible to use the skirt from both ends, the skirt being flipped to the next half when one half of it gets eroded from use.

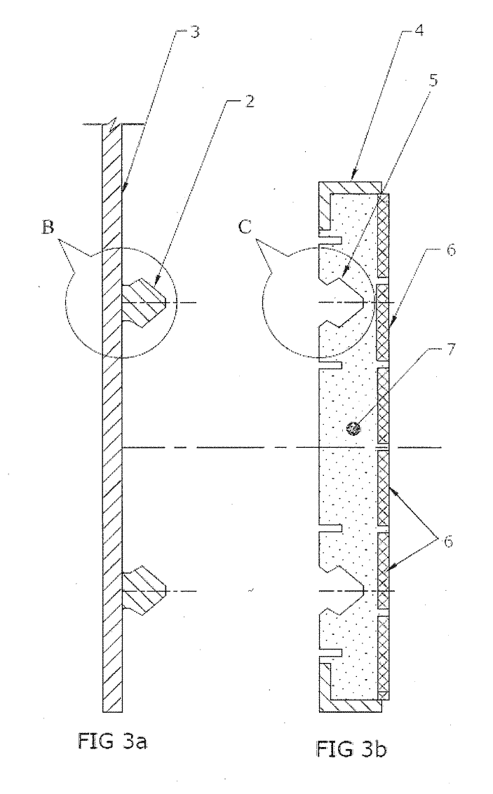

Attention is now drawn to FIGS. 3a and 3b which show details of the snap-lock arrangement according to this invention. The fixing arrangement comprises of a male part (2) made of steel and a mother plate (3), also made of steel, best shown in FIG. 3a. The male part (2) is adapted to go into a female part (5) formed in the liner (7), best shown in FIG. 3b. Steel reinforcement (4) of the skirt liner is provided on the top portion, as shown in this figure.

The male part (2) may either be fixed by welding to the mother plate (3) or it may be an integral part of the mother plate, in which case the mother plate is manufactured with the projected male parts. The snap-lock fixing takes place when a plurality of the male parts (2) provided on the inner face of the ceramic skirt is inserted into their corresponding plurality of female parts (5) provided on the liner (7), which is made of either rubber or PU or polymer or elastomer.

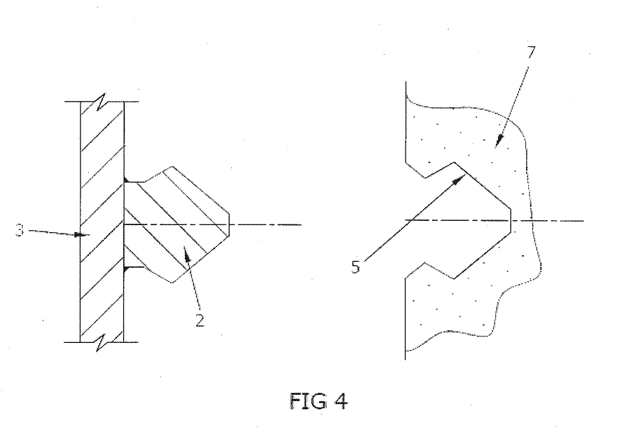

FIG. 4 shows the contour details of both the male part (2) {view of the portion marked ‘B’ in FIG. 3a} and the female part (5) {view of the portion marked ‘C’ in FIG. 3b}. The external contour of the male part (2) matches exactly the internal contour of the female part (5), such that there is a snap fit between these two parts when the male part is inserted into the female part to form the snap-lock fixing arrangement. In this position, the snap-lock fixing arrangement (1) does not allow the liner to move in any direction. This eliminates the chances of falling as well as loosening of the fixing arrangement completely. This innovative fixing arrangement has got the flexibility of using any type of ceramic tiles such as square/hexagonal/interlocking type in Rubber as well as PU, provided with steel angle frame on all sides for rigidity.

This innovative fixing arrangement provided on skirt liners ensures easy handling due to lower weight as there is no steel backing plate and the overall weight is reduced by 70 to 80% as well as with ease of fixing at site.

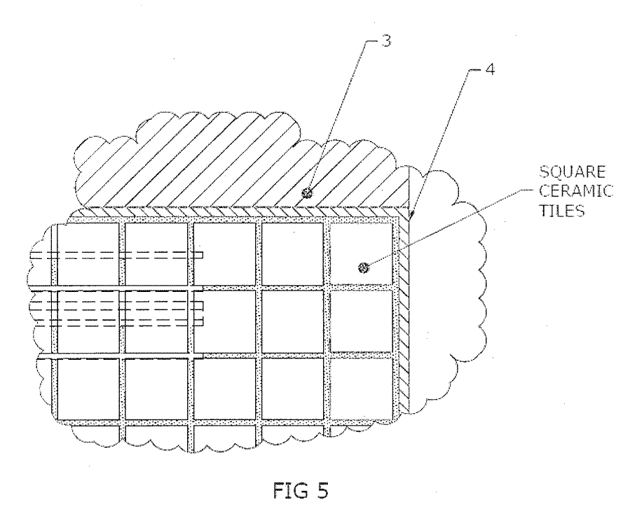

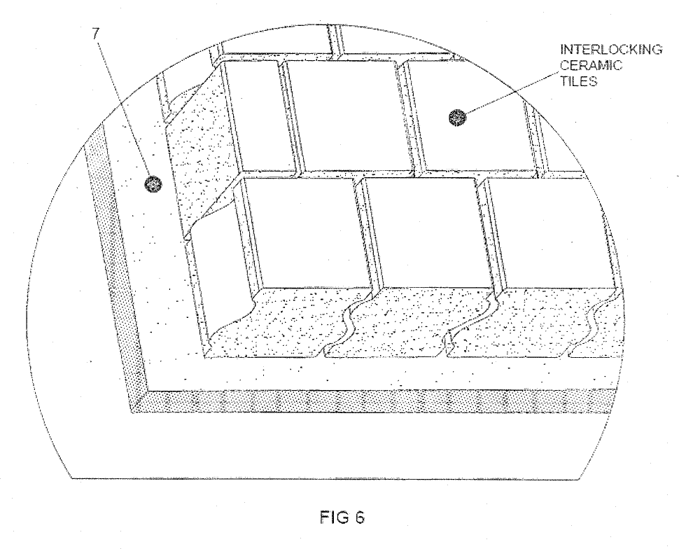

FIG. 5 shows the details of a square ceramic tiles arrangement and FIG. 6 an interlocked type arrangement of ceramic tiles (6), both of which can use the snap-lock fixing arrangement according to the present invention described above.

The present invention has been described with reference to some drawings and a preferred embodiment purely for the sake of understanding and not by way of any limitation and the present invention includes all legitimate developments within the scope of what has been described herein before and claimed in the appended claims.

1. A wear-resistant ceramic liner with snap-lock fixing arrangement, the snap-lock fixing arrangement comprising:
a plurality of male parts positioned on mother plate;
a plurality of corresponding female parts formed on the liner; and,
wherein the external contour of the male parts matches exactly the internal contour of the corresponding female parts such that there is a snap fit between these two parts when the male part is inserted into the corresponding female part to form the snap-lock fixing arrangement.

2. The wear-resistant ceramic liner with snap-lock fixing arrangement as claimed in claim 1, wherein the male part is integral to the mother plate.

3. The wear-resistant ceramic liner with snap-lock fixing arrangement as claimed in claim 1, wherein the male part is welded to the mother plate.

4. The wear-resistant ceramic liner with snap-lock fixing arrangement as claimed in claim 1, wherein the ceramic liner is a square ceramic tiles arrangement.

5. The wear-resistant ceramic liner with snap-lock fixing arrangement as claimed in claim 1, wherein the ceramic liner is an interlocked type arrangement of ceramic tiles.
